(19) United States
(12) Patent Application Publication
(10) Pub. No.: US 2011/0173983 A1
(43) Pub. Date: Jul. 21, 2011

(54) PREMIX FUEL NOZZLE INTERNAL FLOW PATH ENHANCEMENT

(75) Inventors: Mark William PINSON, Greer, SC (US); Jason Thurman STEWART, Greer, SC (US); Jagadish Kumar PERINGAT, Greenville, SC (US); Gregory Earl JENSEN, Greenville, SC (US); Jason Patrick TUMA, Taylors, SC (US)

(73) Assignee: GENERAL ELECTRIC COMPANY, Schenectady, NY (US)

(21) Appl. No.: 12/688,050

(22) Filed: Jan. 15, 2010

(51) Int. Cl. F02C 7/22

(52) U.S. Cl. 60/742

(57) ABSTRACT

A nozzle for gas turbine includes a tubular nozzle body; and a plurality of hollow fuel injection pegs extending radially from the tubular nozzle body at a location between forward and aft ends of the tubular nozzle body; wherein each of the plurality of hollow fuel injection pegs has an external tear-drop cross-sectional shape, and a fuel passage in each of the hollow injection pegs has a substantially matching internal tear-drop cross-sectional shape.

This invention relates to gas turbine combustor technology and more especially to a gas turbine fuel nozzle construction with enhanced internal flow path design.

### BACKGROUND OF THE INVENTION

In a typical “can-annular” type gas turbine combustor arrangement, several combustors are arranged in an annular array about the turbine rotor axis and supply combustion gases to the first stage of the turbine. A compressor pressurizes inlet air which is then turned in direction (or reverse flowed) to the combustor where it is used to cool the hot gas path components and to provide air to the combustion process. Each combustor assembly comprises a generally cylindrical combustor (incorporating a combustor chamber), a fuel injection system, and a transition piece or duct that guides the flow of the hot combustion gas from the combustor to the inlet of the turbine section. Gas turbines of this type typically may include 6, 10, 14 or 18 combustors arranged about the turbine rotor axis.

One specific dry low NOx emission combustion system includes a fuel injection system for each combustor which is comprised of multiple fuel nozzles supported on an end cover that closes the upstream end of the combustor. Each fuel nozzle includes a swirler and a radially oriented peg assembly downstream of the swirler. The swirler and peg assembly may be a one-piece casting or a multi-piece casting or fabricated assembly, and there are typically 8-10 pegs extending radially away from the fuel nozzle body. Each hollow peg has a teardrop outer shape and an internal round bore supplying fuel to multiple holes or orifices by which the fuel is injected into the combustion chamber. The radially outer ends of the pegs are closed by plugs which cover one or more of the orifices, requiring additional drilling through the plugs to re-open the orifices. In addition, the plugs cause an unwanted internal “step” in the flow path. At the same time, and for certain other low NOx combustion systems, higher fuel flows must be accommodated while maintaining a predetermined fuel supply pressure and the same exterior shape and dimensions. Thus, the internal passages must be enhanced to accommodate the higher flows while maintaining the outer geometry substantially unchanged.

### BRIEF DESCRIPTION OF THE INVENTION

In one exemplary but non-limiting embodiment, there is provided a nozzle for gas turbine comprising a tubular nozzle body; and a plurality of hollow fuel injection pegs extending radially from the tubular nozzle body at a location between forward and aft ends of the tubular nozzle body; wherein each of the plurality of hollow fuel injection pegs has an external tear-drop cross-sectional shape, and a fuel passage in each of the hollow injection pegs has a substantially matching internal tear-drop cross-sectional shape.

In another exemplary but non-limiting embodiment, there is provided a nozzle for a gas turbine comprising a tubular nozzle body; and a plurality of hollow fuel injection pegs extending radially from the tubular nozzle body at a location between forward and aft ends of the tubular nozzle body; a plurality of hollow fuel injection pegs extending substantially perpendicularly radially from the tubular nozzle body at a location between the forward and aft ends; and wherein the tubular nozzle body has a base flange attached to a forward end thereof, the base flange formed with an annular array of elongated arcuate fuel inlet slots for supplying fuel to a passage in the tubular nozzle body which connects to the plurality of fuel injection pegs.

In yet another exemplary but non-limiting embodiment, there is provided the nozzle for a gas turbine comprising a tubular body; and a plurality of hollow fuel injection pegs extending radially from the tubular nozzle body at a location between forward aft ends of the tubular nozzle body; wherein each of the plurality of hollow fuel injection pegs has a radially outer end wall, wherein a fuel passage in each of the hollow injection pegs has a substantially smooth surface extending continuously between said tubular nozzle body and the radially outer end wall.

The invention will now be described in greater detail in connection with the drawings identified below.

### BRIEF DESCRIPTION OF THE DRAWINGS

FIG. 1 is a cross section through a can-annular type gas turbine combustor;

FIG. 2 is a perspective view of a nozzle construction which may be used in the combustor of FIG. 1;

FIG. 3 is a cross section of a modified nozzle in accordance with an exemplary but nonlimiting embodiment of the invention;

FIG. 4 is a perspective view of a nozzle end cover mounting flange also called a “base flange” removed from the nozzle of FIG. 3;

FIGS. 5 and 6 are perspective views of alternative base flange configurations;

FIG. 7 is an enlarged partial perspective view of a fuel injection peg as in FIG. 3, sectioned to show more clearly a radiused corner at the radially inner edge of the peg and a solid outer tip portion in accordance with an exemplary but non-limiting embodiment of the invention;

FIG. 8 is a perspective view generally similar to FIG. 7 but showing a prior plug closing the remote end of the fuel injection peg;

FIG. 9 is an enlarged detail illustrating the inlet to the hollow peg shown in FIG. 7 in accordance with an exemplary but non-limiting embodiment of the invention; and

FIG. 10 is a perspective view, partially cut away, of a swirler portion of the nozzle removed from FIG. 3.

### DETAILED DESCRIPTION OF THE INVENTION

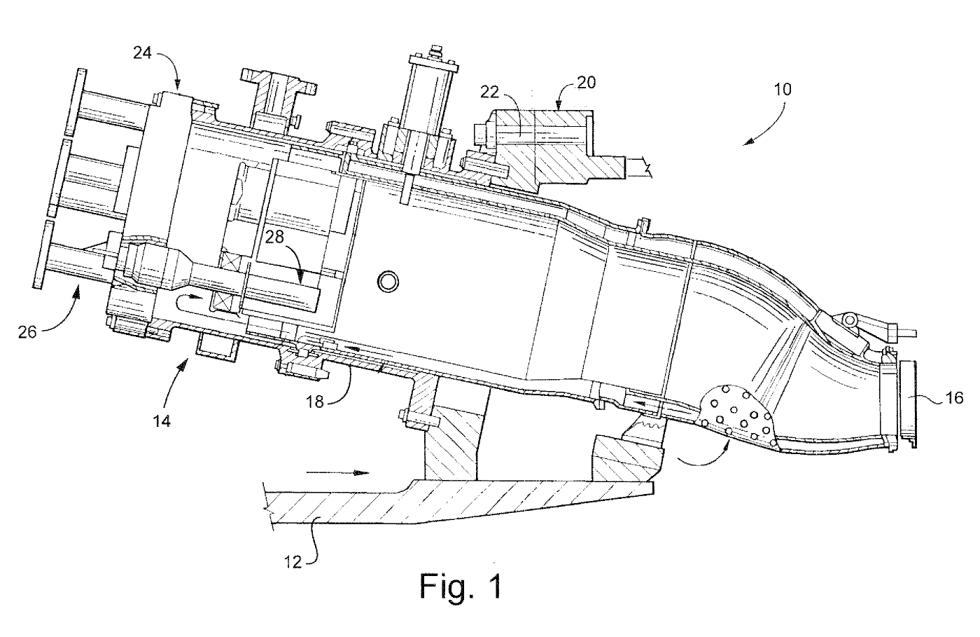

With reference to FIG. 1, a gas turbine 10 includes a compressor casing 12 (partially shown), a plurality of combustors 14 (one shown), and a turbine inlet section represented here by a single turbine nozzle blade 16. Although not specifically shown, the turbine blading is drivingly connected to the compressor rotor along a common axis. The compressor pressurizes inlet air which is turned and reverse flowed (as shown by the flow arrows) to the combustor 14 where it is used to cool the combustor and to provide air to the combustion process.

More specifically, each combustor 14 includes a substantially cylindrical combustor casing 18 which is secured to the turbine casing 20 by means of, for example, bolts 22. The forward end of the combustor casing is closed by an end cover assembly 24 which may include conventional supply tubes, manifolds and associated valves (indicated generally at 26), etc. for feeding gas, liquid fuel and air (and water if desired) to the combustion chamber. The end cover assembly 24 receives a plurality (for example, five) of diffusion/premix fuel nozzle assemblies 28 (only one shown for purposes of convenience and clarity) arranged in a circular array about a longitudinal axis of the combustor.

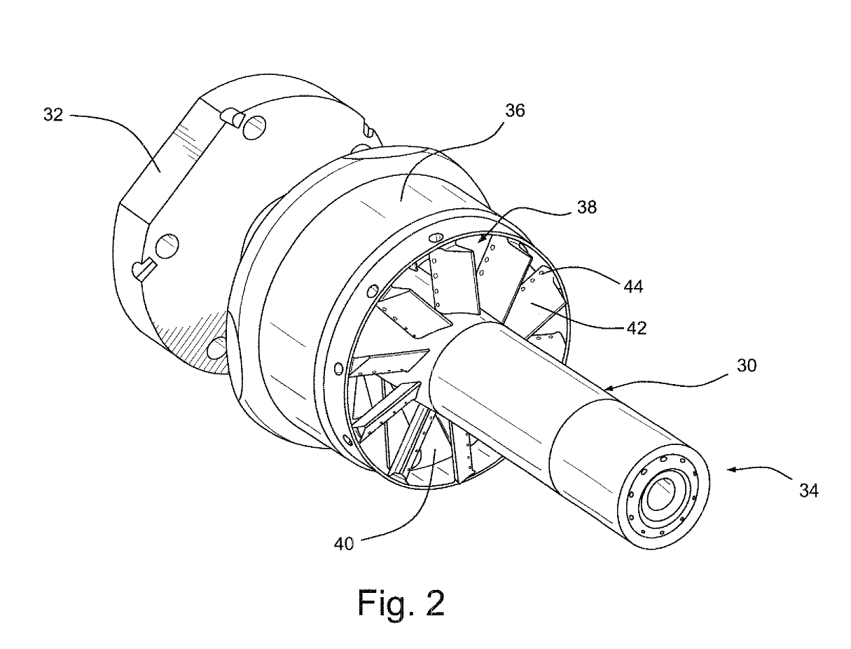

Turning to FIG. 2, the diffusion/premix fuel nozzle assembly 28 show in FIG. 1 includes a nozzle body 30 connected to a rearward supply section or base flange 32, and a forward fuel/air delivery section 34. The nozzle assembly includes a collar 36 which defines an annular passage 38 between the collar 36 and the nozzle body 30. Within this annular passage are air swirler vanes 40, upstream of a plurality of radial fuel injection tubes or pegs 42, each of which is formed with a plurality of discharge orifices 44 for discharging premix gas into and downstream of the annular passage 38. The components 36, 40 and 42 together comprise a swirler that can be cast as a single piece or fabricated from discrete components. Additional details concerning the nozzle construction may be found in commonly-owned U.S. Pat. No. 5,685,139.

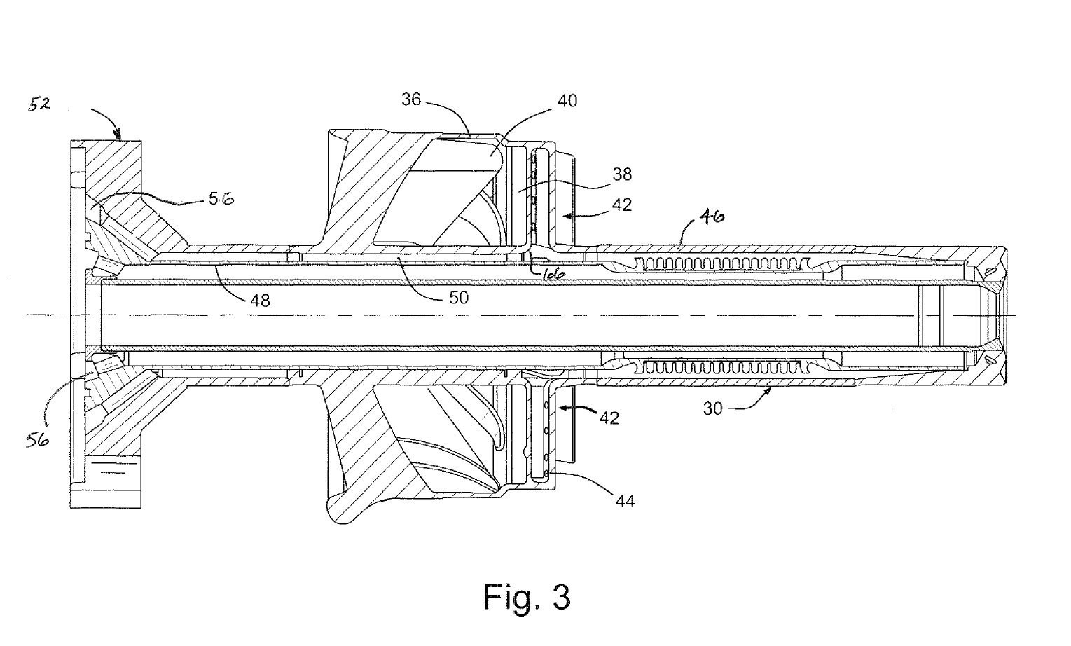

With reference now to FIG. 3, the nozzle body illustrated is similar to that shown in FIG. 2 but with internal modifications as discussed below. Thus, the nozzle body includes a radially outer tube 46 surrounding an intermediate tube 48, defining a radially outermost passage 50 for carrying premix fuel gas to the premix zone, as described further below. The passage 50 is closed at the forward, apertured tip of the nozzle, forcing the premix gas to exit the discharge orifices 44 in the radial fuel injection pegs 42 and into the premix zone.

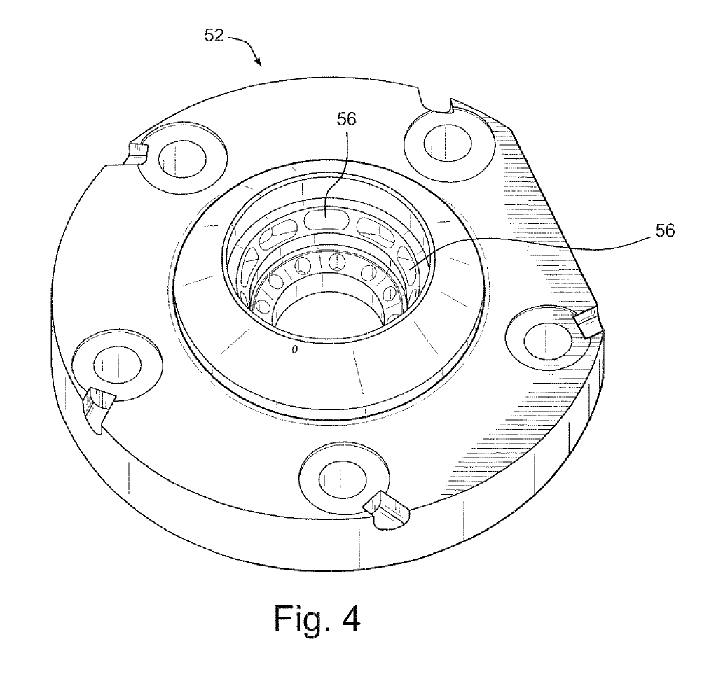

With reference also to FIG. 4, in an exemplary but nonlimiting aspect, the invention provides a first flow enhancement design feature in a nozzle base flange 52 which is otherwise similar to the previously described base flange 32 (FIG. 3). The previously round feedholes have now been reconfigured to arcuate slot feedholes 56 in order to increase the effective area of the flowpath into the passage 50 supplying fuel to the radially-oriented fuel injection pegs 42, and decreasing the local pressure loss. The arcuate extent and circumferential spacing of the reconfigured feedholes 56 may be varied as needed to meet specific requirements.

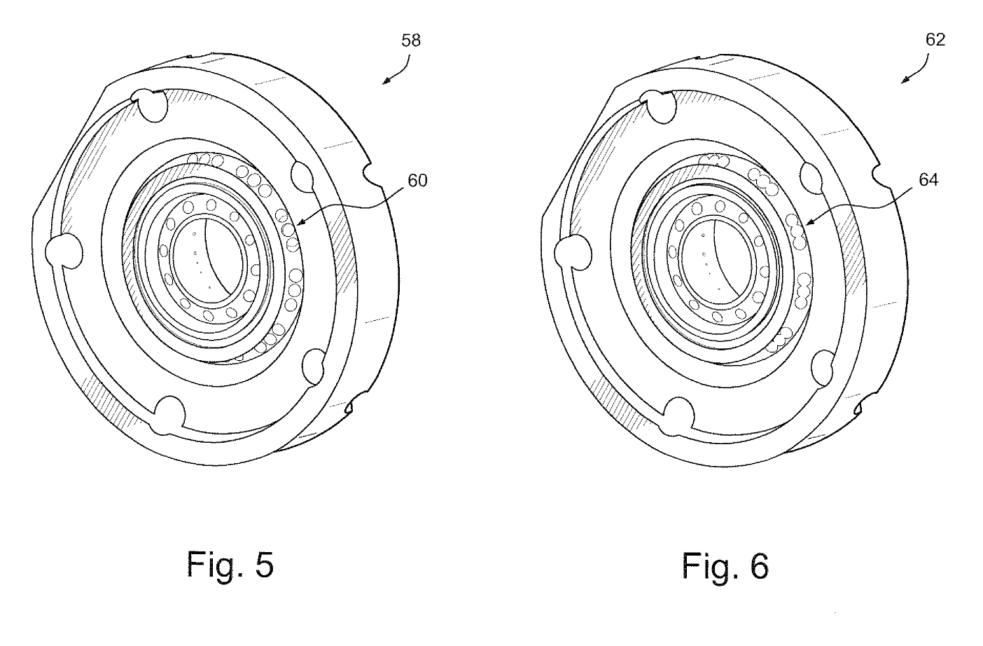

FIGS. 5 and 6 illustrate alternative base flange constructions designed to increase the effective area of the fuel flow path into the passage 50. In FIG. 5, for example, the prior single feed hole configuration has been replaced by individual groups of closely-spaced feed holes indicated generally at 60. In FIG. 6, the feed holes are even more closely spaced with overlapping diameters that effectively create elongated slots generally indicated at 64.

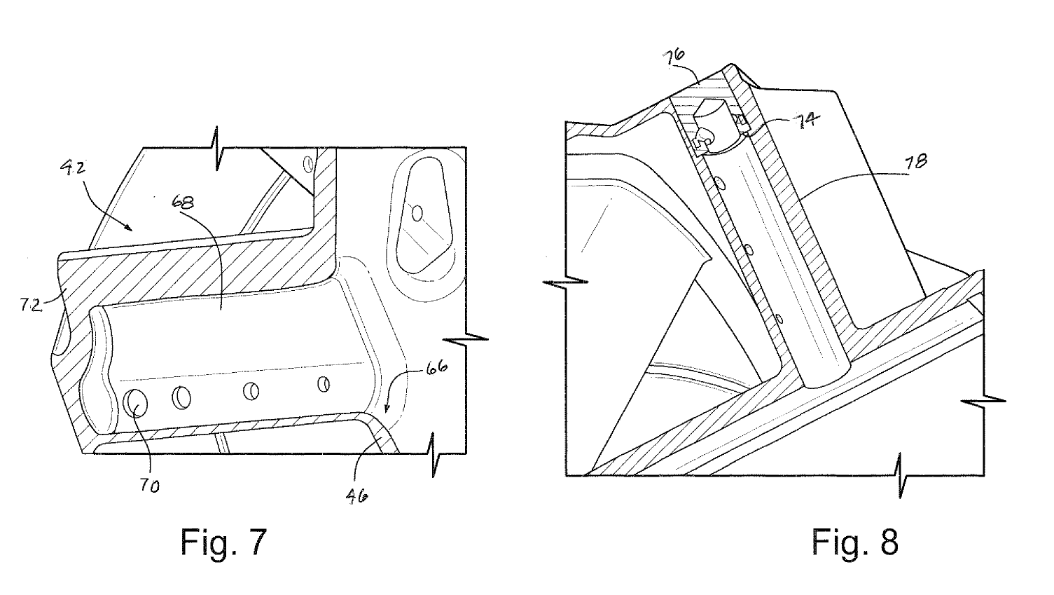

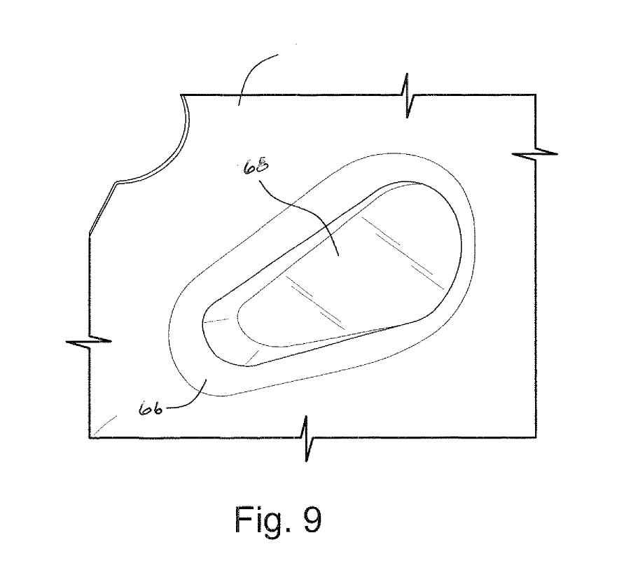

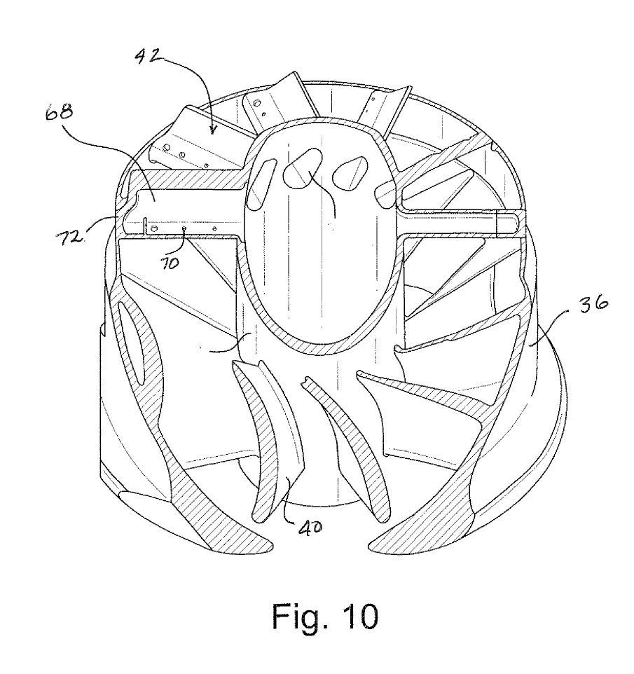

FIGS. 7, 9 and 10 illustrate in more detail the additional flow-enhancement features relating to the internal design aspects of the radial fuel injection tubes or pegs 42 and the interface with the radially outer tube 46 of the nozzle body 30. In the reconfigured design, each radial fuel injector peg 42 interfaces with the radially outer tube 46 at a rounded inlet 66. Preferably, the rounded inlet is defined by a radius in the range of between about 0.06 and about 0.19 inches. The previous substantially 90° turn into the hollow peg caused additional pressure loss and the rounded entry is provided to smooth the turn and decrease the pressure loss.

In addition, the radial bore in the prior externally tear-drop shaped fuel injector pegs 42 were round, and located in the wider or leading edge of the tear-drop-shaped peg. In the reconfigured peg, the internal radial passage 68 is matched to the external tear-drop shape, thereby increasing the internal volume of the peg and, in effect, creating a plenum for more accurately optimal feeding of the plural injector holes 70 in the peg.

At the same time, enlarging the internal volume of the passage 68 during the blind casting or other fabrication process employed to make the swirler (36, 40, 42), also makes it possible to create an integral tip or end wall 72, thereby eliminating a commonly found step or shoulder 74 in plug (integral or added) 76 utilized to close the remote end of the fuel injection peg 78 (see FIG. 8). This also eliminates the need to drill through the plug to open the otherwise blocked-off injection holes. Now, the tear-drop shaped internal radial passage 68 has a smooth, continuous and uniform cross-sectional shape extending from the tube 46 to the end wall 72. It will be appreciated that the end wall 72 may also be a separate cap either welded or brazed to the peg but, in any event, the internal cross-section of the passage 68 is not disturbed.

The above-described flow enhancements enable the nozzle to handle higher flows with minimum modifications; minimizes unwanted pressure losses; and permits optimization of the fuel injection profile.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A nozzle for gas turbine comprising:
a tubular nozzle body; and
a plurality of hollow fuel injection pegs extending radially from said tubular nozzle body at a location between forward and aft ends of said tubular nozzle body; wherein each of said plurality of hollow fuel injection pegs has an external tear-drop cross-sectional shape, and a fuel passage in each of said hollow injection pegs has a substantially matching internal tear-drop cross-sectional shape.

2. The nozzle of claim 1 wherein said tubular nozzle body has a base flange attached to a forward end thereof, said base flange formed with an annular array of elongated arcuate fuel inlet slots for supplying fuel to a passage in said tubular nozzle body which connects to said plurality of fuel injection pegs.

3. The nozzle of claim 1 wherein radially outer ends of said plurality of fuel injection pegs are each closed by a core cap having an end wall, said internal tear-drop cross-sectional shape extending continuously between said tubular nozzle body and said end wall; and further wherein an internal interface surface between each of said plurality of hollow fuel injection pegs and said tubular nozzle body is rounded.

4. The nozzle of claim 3 wherein said internal interface surface is rounded on a radius of between about 0.06 and 0.19 inches.

5. The nozzle of claim 2 wherein radially outer ends of said plurality of fuel injection pegs are each closed by a cap having an end wall, said internal tear-drop cross-sectional shape extending continuously between said tubular nozzle body and said end wall; and further wherein an internal interface surface between each of said plurality of hollow fuel injection pegs and said tubular nozzle body is rounded.

6. The nozzle of claim 5 wherein said internal interface surface is rounded on a radius of between about 0.06 and 0.19 inches.

7. The nozzle of claim 2 wherein said passage is defined by a radial space between a first radially outer tube of said tubular nozzle body and a second intermediate tube located concentrically within said tubular nozzle body.

8. The nozzle of claim 3 wherein said core cap is integral with said hollow fuel injection peg.

9. A nozzle for a gas turbine comprising a tubular nozzle body; and a plurality of hollow fuel injection pegs extending radially from said tubular nozzle body at a location between forward and aft ends of said tubular nozzle body; and wherein said tubular nozzle body has a base flange attached to a forward end thereof, said base flange formed with an annular array of elongated arcuate fuel inlet slots for supplying fuel to a passage in said tubular nozzle body which connects to said plurality of fuel injection pegs.

10. The nozzle of claim 9 wherein each of said hollow fuel injection pegs has an internal tear-drop cross-sectional shape, and wherein radially outer ends of said plurality of fuel injection pegs are each closed by an end wall, said internal tear-drop cross-sectional shape extending continuously between said tubular nozzle body and said end wall.

11. The nozzle of claim 10 an internal interface surface between each of said plurality of hollow fuel injection pegs and said tubular nozzle body is rounded.

12. The nozzle of claim 11 wherein said internal interface surface is rounded on a radius of between about 0.06 and 0.19 inches.

13. The nozzle of claim 9 wherein said elongated arcuate fuel inlet slots extend at an acute angle relative to said passage.

14. The nozzle of claim 11 wherein said elongated arcuate fuel inlet slots are each formed by plural round holes formed with overlapping diameters.

15. The nozzle for a gas turbine comprising:
a tubular body; and
a plurality of hollow fuel injection pegs extending radially from said tubular nozzle body at a location between forward aft ends of said tubular nozzle body; wherein each of said plurality of hollow fuel injection pegs has a radially outer end wall, wherein a fuel passage in each of said hollow injection pegs has a substantially smooth surface extending continuously between said tubular nozzle body and said radially outer end wall.

16. The nozzle of claim 15 wherein said radially outer end wall is integral with said hollow fuel injection peg.

17. The nozzle of claim 15 wherein an internal interface surface between each of said plurality of hollow fuel injection pegs and said tubular nozzle body is rounded on a radius designed to smooth flow of fuel into said plurality of fuel injection pegs.

18. The nozzle of claim 17 wherein said internal interface surface is rounded on a radius of between about 0.06 and 0.19 inches.

19. The nozzle of claim 15 wherein said radially outer end wall is a discrete cap secured to said hollow injection peg.

20. The nozzle of claim 19 wherein said discrete cap is welded or brazed to said hollow fuel injection peg.
